(19) United States
(12) Patent Application Publication
(10) Pub. No.: US 2015/0025687 A1
(43) Pub. Date: Jan. 22, 2015

(54) REMOTE-CONTROLLED FOOD-RELATED APPLIANCE

(71) Applicant: HomeSquared Corporation, Bloomington, MN (US)

(72) Inventors: Cameron Henderson, Bloomington, MN (US); Josh Maslowski, St. Louis Park, MN (US)

(73) Assignee: HomeSquared Corporation, Bloomington, MN (US)

(21) Appl. No.: 14/267,604

(22) Filed: May 1, 2014

Related U.S. Application Data
(60) Provisional application No. 61/856,833, filed on Jul. 22, 2013.

(51) Int. Cl. A23B 4/052; G05B 15/02

(52) U.S. Cl. CPC A23B 4/052; G05B 15/02
USPC 700/275; 99/339

(57) ABSTRACT

A system includes: a smoking appliance; a remote computing device; and a communication network; wherein the smoking appliance and the remote computing device are in communication via the communication network; and wherein a user of the remote computing device controls the smoking appliance remotely.

### CROSS REFERENCE TO RELATED APPLICATION

This application claims the benefit of U.S. patent application Ser. No. 61/856,833 entitled “Remote-Controlled Food-Related Appliance,” filed Jul. 22, 2013, the entirety of which is hereby incorporated by reference.

### BACKGROUND

Many types of cooking and smoking require low temperatures, long hours, and intermittent monitoring. These cooking methods can be inconvenient. Additionally, most traditional cooking-related appliances require the operator to be physically in the same location as the appliance in order to make any modifications to the cooking apparatus.

### SUMMARY

In one aspect, a system includes: a smoking appliance; a remote computing device; and a communication network; wherein the smoking appliance and the remote computing device are in communication via the communication network; and wherein a user of the remote computing device controls the smoking appliance remotely.

In another aspect, a method for controlling a smoking appliance includes: accessing an application; entering a time a food should remain in an appliance; entering a temperature for the appliance; initiating operation of the appliance; and monitoring the appliance remotely.

### DESCRIPTION OF THE FIGURES

FIG. 1 illustrates one embodiment of a cooking system including a cooking-related appliance, a communication network, and a remote computing device.

FIG. 2 illustrates one embodiment of a control module that may be located on the cooking-related appliance of FIG. 1.

FIG. 3 illustrates one embodiment of a mobile application interface on the remote computing device of FIG. 1.

FIG. 4 illustrates one embodiment of the live smoking information presented in the mobile application interface of the remote computing device of FIG. 3.

FIG. 5 illustrates one embodiment of the start new smoke options presented in the mobile application interface of the remote computing device of FIG. 3.

FIG. 6 illustrates one embodiment of a display of the current core food temperature interface, as presented in the mobile application interface of the remote computing device of FIG. 3.

FIG. 7 illustrates one embodiment of a display of the start new smoke interface, as presented in the mobile application interface of the remote computing device of FIG. 3.

FIG. 8 illustrates one embodiment of the decisional flowchart of starting a new smoke using the mobile application interface of the remote computing device of FIG. 3.

### DETAILED DESCRIPTION

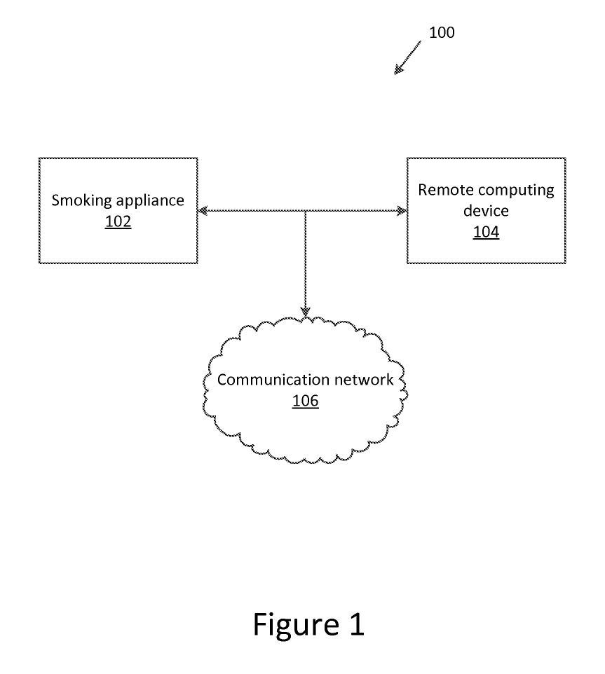

FIG. 1 is a schematic block diagram illustrating an example system 100 for smoking and/or cooking food. In this example, the system 100 includes a smoking appliance 102, a remote computing device 104, and a communication network 106. In the example system, the smoking appliance 102 and remote computing device 104 are in communication via the communication network 106. The example system is not limited to smoking food.

The smoking appliance 102 functions to, in any combination, cook, smoke, grill, bake, broil, blanch, braise, roast or steam, food. Types of food that may be used in the system 100 include, for example, beef, lamb, pork, poultry, fish, game, shellfish, vegetables and cheese. In some embodiments, the smoking appliance 102 has a door, lid, or other method of closing or sealing the cooking or smoking environment. In other embodiments, the smoking appliance 102 has one or more shelves.

In one embodiment, the smoking appliance 102 is a charcoal grill. In another embodiment, the smoking appliance 102 is a gas-fired grill. In still another embodiment, the smoking appliance 102 is an electric appliance designed for smoking or slow-cooking food. In yet another embodiment, the smoking appliance 102 contains both a heating element and a separate smoking element. In yet other embodiments, the smoking appliance 102 can be configured to cook food according to other methodologies.

In one embodiment, the smoking appliance 102 is connected to the communication network 106. The communication network 106 is, in turn, connected to the remote computing device 104. This connection may include any type of wireless network, a wired network, or any communication network known in the art. For example, wireless connections can include connections made using protocols such as 802.11a, b, and/or g. In other examples, a wireless connection can be accomplished directly between the smoking appliance 102 and the remote computing device 104 using one or more wired or wireless protocols, such as Bluetooth, Wi-fi Direct, and Zigbee. Other configurations are possible.

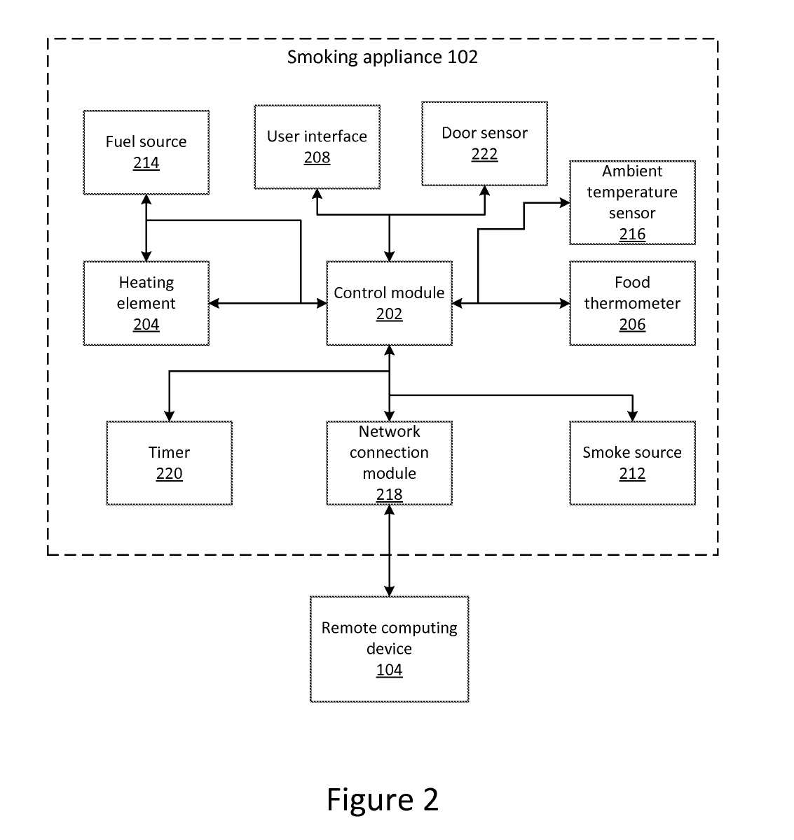

In some embodiments, the smoking appliance 102 contains a control module 202, as shown in FIG. 2. In some embodiments, the control module 202 has a user interface 208, which may be a display. The user may make modifications to the smoking appliance 102 through the user interface. In other embodiments, the smoking appliance 102 does not have a display connected to the control module 202. In such a scenario, the control module 202 is controlled using a separate device, such as the remote computing device 104. The example smoking appliance 102 is shown in more detail in FIG. 2, which is described further below.

The example remote computing device 104 functions to communicate, via the communication network, with the smoking appliance 102. In one embodiment, the user may, in addition to making modifications to the cooking or smoking conditions on the display located on the smoking appliance 102, use the mobile application interface 300 on the remote computing device 104 to monitor or modify cooking or smoking conditions.

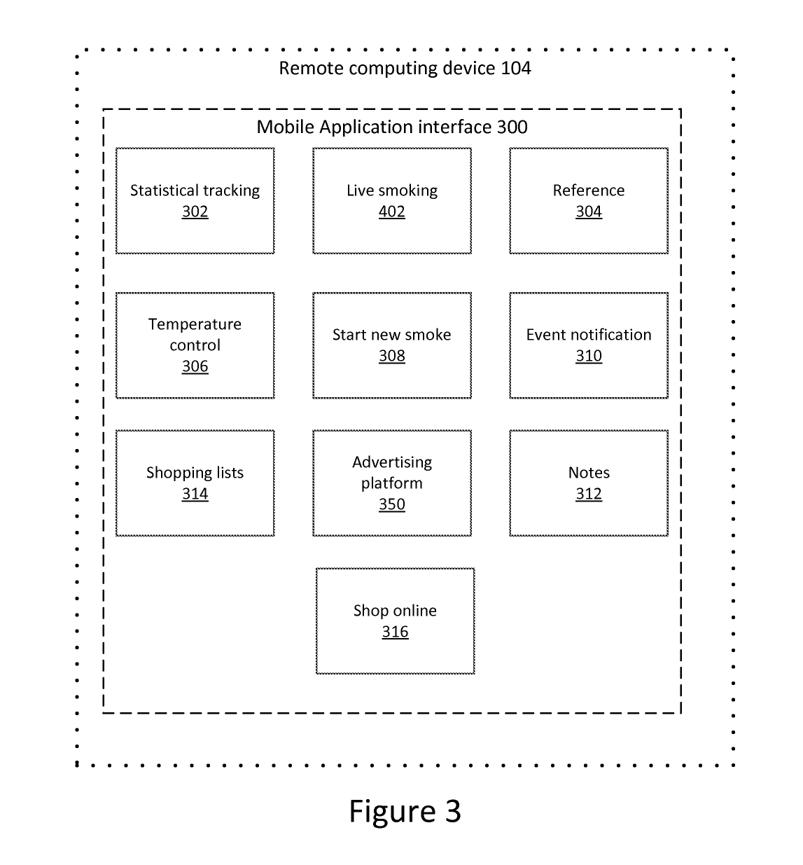

The remote computing device 104 may be any device capable of sending or receiving data over a communication network 106. Examples include, but are not limited to, mobile phones, tablet personal computers, laptop computers, desktop computers, personal digital assistants, or wearable devices such as watches, bracelets or “smart” glasses. Example interfaces to be accessed on the remote computing device 104 are shown in more detail in FIGS. 3-7.

In these examples, the remote computing device 104 includes one or more processing units and computer readable media. Computer readable media includes physical memory such as volatile memory (such as RAM), non-volatile memory (such as ROM, flash memory, etc.) or some combination thereof. Additionally, the remote computing device 104 can include mass storage (removable and/or non-removable) such as a magnetic or optical disks or tape. An operating system, such as Linux or Windows, and one or more application programs can be stored on the mass storage device. The remote computing device 104 can include input devices (such as a keyboard and mouse) and output devices (such as a monitor and printer).

The remote computing device 104 also includes network connections to other devices, computers, networks, servers, etc., such as through the communication network 106. In example embodiments, the remote computing device 104 communicates with other components through one or more networks (e.g., the communication network 106), such as a local area network (LAN), a wide area network (WAN), the Internet, or a combination thereof. Communications can be implemented using wired and/or wireless technologies, as described herein.

FIG. 2 is a schematic block diagram illustrating example components of the smoking appliance 102. In this example, the smoking appliance 102 includes the control module 202, a heating element 204, a food thermometer 206, a user interface 208, a smoke source 212, a fuel source 214, an ambient temperature sensor 216, a network connection module 218, a door sensor 222, and a timer 220. Other embodiments may exclude some or all of these components or add additional components.

The control module 202 is in communication with or operates to control the components that are part of the smoking appliance 102. In some embodiments, the example control module 202 is in communication with the heating element 204, the food thermometer 206, the user interface 208, the smoke source 212, the fuel source 214, the ambient temperature sensor 216, the network connection module 218, and the timer 220.

In some embodiments, the control module 202 has a processor and memory, with the same functionalities as the remote computing device 104 described above. In some embodiments, the memory may be stored on a remote device and accessed over a communications network. In some embodiments, the control module 202 functions as a central processing unit or server. Alternatively, some or all of the components in the smoking appliance 102 may have their own processor or memory. In those embodiments, the control module 202 may not be a separate unit but rather the sum of the separate, but in communication, components.

In some embodiments, the control module 202 operates to control the components of the smoking appliance 102 after receiving input from the operator via the user interface 208 or the remote computing device 104. For example, if the user or operator indicates through the remote computing device 104 that the internal food temperature should be 150° F., the remote computing device 104 may send data through the network connection module 218 to the control module 202. That data may contain, for example, a request to the food thermometer 206 for the current core food temperature.

After receiving the current core food temperature from the food thermometer 206, the control module 202 may input that temperature into an algorithm, or send that data back to the remote computing device 104 for inputting into an algorithm, and then determine the required heat flow into the smoking appliance 102. In turn, the control module 202 may, for example, communicate to the heating element 204 and fuel source 214 the proper gas flow into the smoking appliance 102. Accordingly, the fuel source 214 may, for example, adjust the flow of propane gas into the heating element 204.

The heating element 204 is an optional component of the smoking appliance 102 and operates to modulate the ambient temperature of the smoking appliance, either in addition to the smoke source 212 or in place of the smoke source 212. In some embodiments, the smoking appliance 102 does not have a heating element 204. The heating element 204 may influence the ambient temperature by emitting radiant heat. In other embodiments, the heating element may operate in conjunction with an agitating component, such as a fan, such that the heating element provides convective heat. In some embodiments, the control module 202 may close the output valve, or other metering means, of the heating element 204 to begin a cool down period or to stop the emission of heat from the heating element 204 into the smoking appliance 102. The heating element 204 may be connected to a fuel source 214.

Alternatively, the heating element 204 and fuel source 214 comprise a single component. In some embodiments, the heating element 204 may be an electrically-fed resistance element, such as a heating coil. In other embodiments, the heating element 204 receives gas, such as propane or liquefied natural gas, from the fuel source 214 and ignites the incoming gas, using techniques well known in the art, thereby emitting heat to the smoking appliance 102.

In still other embodiments, the fuel source 214, such as charcoal or wood, is placed within the heating element 204, and the heating element has a valve opening or some other means of metering the heat released to the smoking appliance 102. In some embodiments, the control module 202 controls the aperture or other metering means of the heating element 204 as a way to achieve a desired ambient temperature of the smoking appliance 102.

In yet another embodiment, the fuel source 214 has an air intake opening, with a valve or metering means attached thereto, and the control module 202 can regulate heat emitted from the heating element 204 by changing the amount of air allowed into the heating element 204 through the air intake opening. In closing either, or both, the fuel source's 214 air intake or outputs, the control module 202 may cause the smoking appliance 102 to begin a cool down, keep warm, or food resting period.

The fuel source 214 is an optional component of the smoking appliance 102 and operates to provide the heating element 204 with the resources the heating element 204 requires to produce heat. As mentioned above, the fuel source 214 may be a separate, but operatively coupled, component from the heating element 204. Or, in other embodiments, the fuel source 214 and heating element 204 comprise a single component. In some embodiments, the fuel source 214 is a source of electricity, such as an electrical outlet or electric generator. In other embodiments, the fuel source 214 is liquefied natural gas or propane gas. In still other embodiments, the fuel source 214 is charcoal, wood, or some form of biofuel.

The timer 220 is an optional component of the smoking appliance 102 and operates to record the elapsed smoking or cooking time. In some embodiments, the timer 220 communicates to the control module 202, for example through a wired or wireless connection, how long the food has been smoking. In some embodiments, the control module 202 may use the timing information to shut off, or turn on, the heating element 204 or smoke source 212. In other embodiments, the timer 220 and control module 202 comprise one component. In some embodiments, the timer 220 sends the elapsed time to the control module 202, and the control module 202 sends the elapsed time to the remote computing device 104 via the network connection module 218.

The network connection module 218 is an optional component of the smoking appliance 102 and operates to enable communication between the control module 202 and the remote computing device 104. The network connection module 218 may be in wireless or wired communication with the control module 202. In some embodiments, the network connection module 218 and the control module 202 comprise one component.

Additionally, the network connection module 218 is in communication with the communication network 106. In some embodiments, the network connection module 218 communicates with the remote computing device 104 over a wired or wireless connection. In some embodiments, data sent from the remote computing device 104 are received by the network connection module 218 over the communication network 106, and the data pass on to the control module 202.

The smoke source 212 is an optional component of the smoking appliance 102 and provides, in some embodiments, smoke or heat to the smoking appliance 102. In some embodiments, the smoke source 212 is in communication with the control module 202 through a wired or wireless connection. The smoke source 212 may, for example, have an air intake opening, with valve or metering means that are operatively coupled to the control module 202. In some embodiments, the smoke source contains an ignition component that is capable of igniting the material that is within the smoke source 212.

In other embodiments, the smoke source 212 has an output valve opening or some other means of metering the smoke released to the smoking appliance 102. In some embodiments, the control module 202 controls the output aperture, or other metering means, of the heating element 204 as a way to achieve a desired ambient temperature of the smoking appliance 102. In other embodiments, the control module 202 changes the valve, or other metering means, of the air input or output of the smoke source 212. In closing either, or both, the smoke source 212 air intake or outputs, the control module 202 may cause the smoking appliance 102 to begin a cool down period.

In some embodiments, organic material may be used as the burned, or smoked, material that is within the smoke source 212. For example, organic material may be leaves or wood from trees, such as alder, oak, beech, hickory, mesquite, pecan, alder, fig, maple, apple, plum, or cherry. In other embodiments, a synthetic material may serve as the material that is burned within the smoke source 212.

The food thermometer 206 is an optional component of the smoking appliance 102 that operates to measure the temperature of the food that is within the smoking appliance 102 and communicate that temperature to the control module 202. The food thermometer 206 may be in communication with the control module 202 via a wired or wireless connection. In some embodiments, the food thermometer 206 sends the measured food temperature to the control module 202, and the control module 202 sends the measured food temperature to the remote computing device 104 via the network connection module 218.

In some embodiments, the food thermometer 206 measures the core temperature of the food. In other embodiments, the food thermometer 206 measures the temperature of the food near the surface of the food. In some embodiments, the food thermometer 206 must be manually inserted into the food by the smoking appliance's 102 operator. In other embodiments, the food thermometer 206 is an infrared thermometer and the food thermometer 206 does not need to be in contact with the food in order to measure the food's temperature. In still other embodiments, the food thermometer is any one of the following, for example, a thermocouple, a thermistor, an oven cord thermometer, a thermometer fork combination, a bimetallic-coil thermometer or a digital instant read thermometer. In yet other embodiments, if the food thermometer 206 measures the food temperature with an analog signal, there is an additional component to convert the analog signal to a digital signal before the measurement is sent to the control module 202.

The ambient temperature sensor 216 is an optional component and operates to measure the ambient temperature of the smoking appliance 102 and communicate that temperature to the control module 202. In some embodiments, the ambient temperature sensor 216 is in communication with the control module 202 via a wired or wireless connection. In some embodiments, the ambient temperature sensor 216 sends the measured ambient temperature of the smoking appliance 102 to the control module 202, and the control module 202 sends the measured ambient temperature to the remote computing device 104 via the network connection module 218.

In some embodiments, the ambient temperature sensor 216 comprises more than one temperature sensor and the recorded temperatures of all the sensors are sent to the control module 202. For example, the smoking appliance 102 may have two ambient temperature sensors 216, one located near the bottom of the appliance and one located near the top of the appliance. In other embodiments, there may be more than two temperature sensors 216, for example, five temperature sensors equally spaced from top to bottom and located on alternating sides of the smoker.

In some embodiments, the compiled data from the more than one temperature sensors provide the control module 202 with any temperature variances that may exist within the smoking appliance 102. In some embodiments, the control module 202 may send these data to the remote computing device 104 via the network connection module 218. In some embodiments, the remote computing device 104 or the control module 202 may activate or deactivate the agitating component of the heating element 204 in response to the received ambient temperature data. In other embodiments, the remote computing device 104 or the control module 202 may open or close the output valve of the heating element 204 or smoke source 212 in response to the received ambient temperature data.

The user interface 208 is an optional component of the smoking appliance 102 and enables, for example, the smoking appliance 102 operator to control the smoking appliance 102. In some embodiments, the user interface 208 is a display located on the outside of the smoking appliance 102. In other embodiments, the user interface 208 is located near the smoking appliance 102 but is not on the outside surface of the smoking appliance 102. In still other embodiments, the user interface 208 is a touch sensitive display. For example, the user interface 208 could be a 7″ LCD touch-sensitive display.

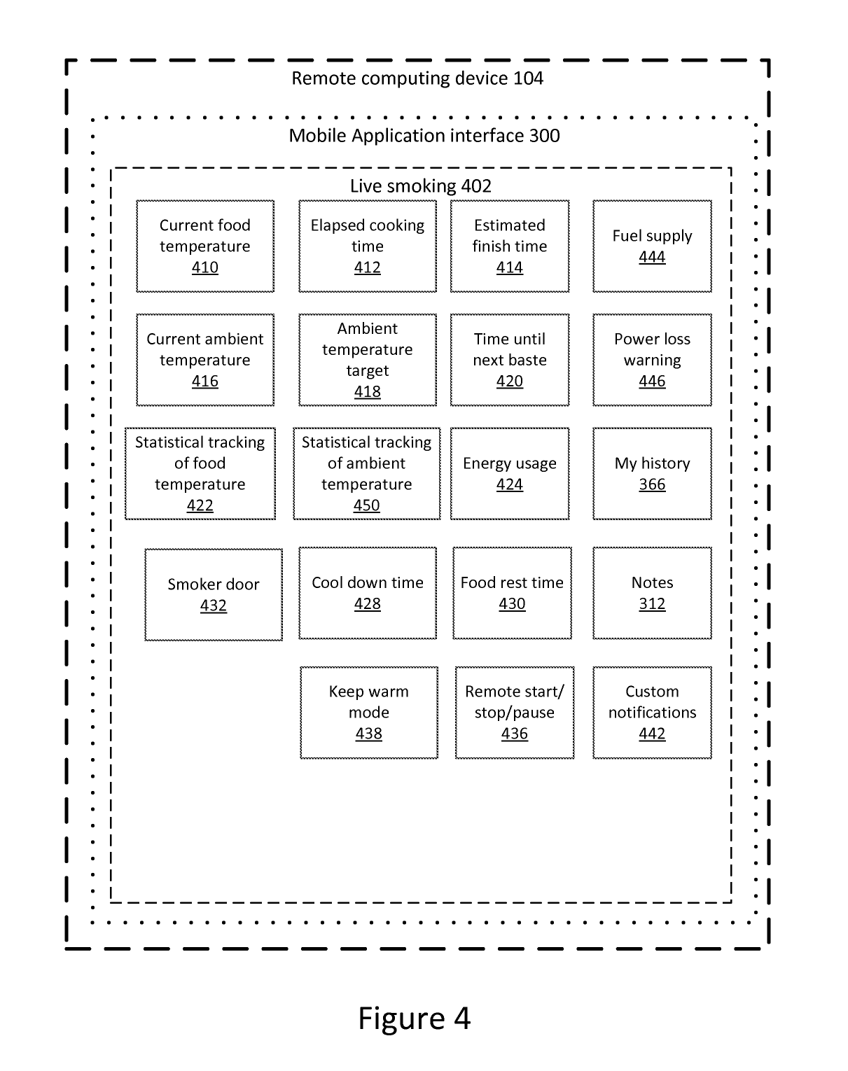

In some embodiments, the user interface 208 enables the operator to begin a smoking or cooking session by inputting the desired smoking or cooking parameters. Examples of smoking or cooking parameters are shown and described in more detail in FIG. 4. In some embodiments, the user interface 208 does not contain all of the parameters shown and described in connection with FIG. 4.

In some embodiments, after the operator inputs the desired smoking or cooking parameters into the user interface 208, the screen may display a large icon. The large icon may contain text such as “start” or “go” and when the operator presses the icon the smoking or cooking session begins. The large icon enables the operator to start the smoking or cooking session by easily pressing the button with one or more fingers, or, alternatively, pressing the button with his or her, for example, elbow, wrist, back or side of hand, chin or forehead. In this embodiment, the large icon advantageously enables the operator, who likely has food-related fluid on their hands, to start the cooking or smoking session without needing to use their fingers.

The door sensor 222 is an optional component in the smoking appliance 102 and operates to record the times the smoking appliance 102 is opened. The smoking appliance has a means for closing the cooking interior, such as a lid or door. In some embodiments, the door sensor 222 may recognize when the door is opened by, for example, an optical or laser circuit, a pair or series of magnets, or any sensor that is known in the art. In some embodiments, the door sensor 222 sends data about the time the door was opened to the control module 202, and the control module 202 may send that data to the remote computing device 104 via the network connection module 218.

FIG. 3 is a block diagram illustrating some of the modules of the mobile application interface 300 which is accessible by the remote computing device 104. The mobile application interface 300 may be a program downloaded onto the remote computing device 104. In other embodiments, the mobile application interface 300 is browser-based, and may be accessed on, for example, a desktop or laptop computer. The mobile application interface has multiple modules, including, for example, a statistical tracking module 302, a live smoking module 402, a reference module 304, a temperature control module 306, a start new smoke module 308, an event notification module 310, a shopping lists module 314, an advertising platform module 350, a notes module 312, and a shop online module 316. Other embodiments may exclude some or all of these modules or add additional modules. In some embodiments, the user's input in one of the mobile application interface's 300 modules is transmitted by the remote computing device 104, through the communication network 106, to the control module 202 via the network connection module 218.

The statistical tracking module 302 is an optional module in the mobile application interface 300, and presents the user with statistics about the current smoking or cooking session. In other embodiments, the statistical tracking module 302 contains stored, or accesses stored data, of previous smoking or cooking sessions. In some embodiments, the statistical tracking module 302 contains multiple views, arranged linearly or hierarchically, and may be customized by the operator.

In some embodiments, the statistical tracking module 302 presents the user with recorded data in graph, table, or other pictorial representation, such as a pie chart or histogram. In some embodiments, the statistical tracking module 302 additionally may present the user with predicted future values based on prior smoking or cooking sessions, algorithms, or both. The table or graph views in the statistical tracking module 302 may be modified by the user to narrow or expand the independent or dependent variables of the graph, table, or other pictorial views.

Examples of past or future data presented in the statistical tracking module 302 include, but are not limited to, many of the components of the smoking appliance 102. For example, the statistical tracking module 302 may present the user with historical or predicted future data about the fuel source 214, the heating element 204, such as the heating element 204 aperture's percent opening, the smoke source, such as the smoke source 212 aperture's percent opening, the food thermometer 206 reading, the ambient temperature sensor 216 reading, or the time or times the smoking appliance's 102 door or lid was opened. The statistical tracking view may contain links to the other modules in the mobile application interface 300.

The live smoking module 402 is an optional module in the mobile application interface 300 and enables the remote computing device 104 user to view information about, and make changes to, the current smoking or cooking session. The live smoking module 402 is shown and described in more detail with reference to FIG. 4.

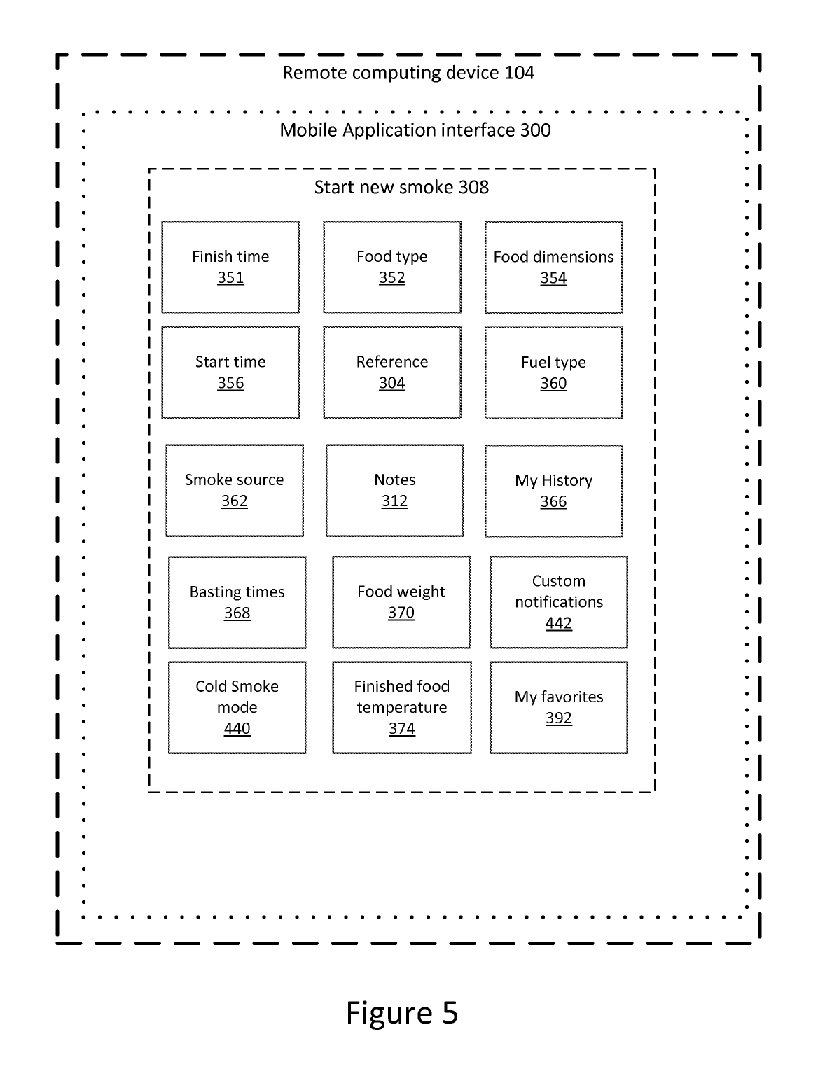

The start new smoke module 308 is an optional module in the mobile application interface 300 and enables the remote computing device 104 user to start a new smoking or cooking session. The start new smoke module 308 is shown and described in more detail with reference to FIG. 5.

The reference module 304 is an optional module in the mobile application interface 300 and contains, or provides access to, cooking or smoking related literature. In some embodiments, the reference module 304 is a searchable database of published or popular recipes. In other embodiments, the mobile application interface 300 user may select a recipe for a smoke session and the instructions and parameters for that smoke session are automatically imported into the start new smoke module 308. In still other embodiments, the user may add or import recipes from external sources, such as a website or email, or enter in their own recipes.

Additionally, the reference module 304 may contain other smoking or cooking related information. For example, the reference module 304 may populate with recent articles written about smoking or cooking. In other embodiments, the mobile application interface 300 user may add or import articles or tips from external sources, such as a website or email. In some embodiments, the reference module 304 organizes the recipes by date, by recipe, by food type, by cooking duration, or by food weight.

The temperature control module 306 is an optional module in the mobile application interface 300 and operates, for example, to control the temperature of the smoking appliance 102. In some embodiments, the temperature control module 306 provides the user with access to the current food temperature module 410, the desired finished food temperature module 374, the current ambient temperature module 416, the ambient temperature target module 418, and statistics about the current session.

In some embodiments, the temperature control module 306 enables the mobile application interface 300 user to change the temperature of the smoking appliance 102. For example, the mobile application interface 300 user may change the desired finished food temperature module 374, the current ambient temperature module 416, or the ambient temperature target module 418. The mobile application will enter the new parameter settings into one or more algorithms, send data to the control module 202, and the control module 202 will adjust the inlet or output of the heating element 204 or the smoke source 212. In other embodiments, the temperature control module 306 enables the mobile application interface 300 user to modify the inlet and output of the heating element 204 or the smoke source 212.

The event notification module 310 is an optional module in the mobile application interface 300 and operates to provide the application user to receive notifications about the current smoking or cooking session. In some embodiments, the user may elect to receive notifications as, for example, an instant message, an email, an SMS, a push notification, a banner notification, on, for example, the remote computing device 104, a desktop computer, a laptop computer, or some other device capable of communicating over the communication network 106.

In some embodiments, the user may set alerts through the event notification module 310 for when, for example, any of the following occur: the lid or door to the smoking appliance opens 222, the fuel source 214 is low, the timer 220 reaches the set time limit, the ambient temperature of the smoking appliance 102 reaches the set target, the food temperature reaches the set target, the inlet or output of the heating element 204 or smoke source 212 are non-responsive, or the remote computing device 104 is unable to connect to the control module via the communication network 106. The user may customize the event notification module 310 via the custom notifications module 442, illustrated and described in more detail with reference to FIG. 4.

The shopping lists module 314 is an optional module in the mobile application interface 300 and operates to organize selected recipes in the reference module 304 into a shopping list. In some embodiments, the user may select a recipe in the reference module 304 and the mobile application will convert that recipe into a shopping list. In some embodiments, the shopping lists module 314 will organize the ingredients according to typical areas of a grocery store, for example, dairy, meat, fish, fresh vegetables, canned goods, spices, frozen, etc. In other embodiments, the user may select more than one recipe from the reference module 304 and the shopping lists module 314 will compile and organize the ingredients.

The advertising platform module 350 is an optional module in the mobile application interface 300 and operates to display advertisements to the mobile application user. In some embodiments, the advertising platform module 350 displays banner advertisements, for example, at the bottom, top, or side of the remote computing device's screen. In other embodiments, the advertising platform module 350 displays advertisements within the mobile application interface 300 modules. In still other embodiments, the advertising platform module 350 customizes the displayed ads for the user, using, for example, the currently selected recipe, prior recipes used, prior smokes, or personal information about the user.

The notes module 312 is an optional module in the mobile application interface 300 and operates to record and organize the user's notes about recipes or past smoking or cooking sessions. In some embodiments, the notes module 312 is also accessible from the live smoking 402 or start new smoke module 308s. In other embodiments, the notes module 312 syncs with an external source, such as a web log or word processing document.

In other embodiments, the user may enter notes about current or past smoking or cooking sessions by typing using the remote computing device's 104 text entry interface or by selecting from a list of pre-entered notes. For example, the user may enter notes that after using a given recipe, the food was undercooked, tough, too smoky, too charred, juicy, cold, overcooked, or inconsistently cooked internally. In some embodiments, the notes module 312 may organize the notes by, for example, date, recipe name, food type, smoke source, or cooking duration.

The shop online module 316 is an optional module in the mobile application interface 300 and operates as a portal for the user to purchase supplies related to the smoking appliance 102. In some embodiments, the shop online module 316 is linked to a user's account with a third party, such as Amazon, Google, Facebook, eBay. In other embodiments, the shop online module 316 displays items related to, for example, smoking, cooking, basting, or components of the smoking appliance 102. In still other embodiments, the shop online module 316 enables the user to purchase items for sale from within the mobile application.

FIG. 4 is a block diagram illustrating some of the sub-modules of the live smoking module 402, which may be accessed through the mobile application interface 300 on the remote computing device 104. The live smoking module 402 has multiple sub-modules, including, for example, a current food temperature module 410, an elapsed cooking time module 412, an estimated finish time module 414, a fuel supply module 444, a current ambient temperature module 416, an ambient temperature target module 418, a time until next baste module 420, a power loss warning module 446, a statistical tracking of food temperature module 422, a statistical tracking of ambient temperature module 450, an energy usage module 424, a my history module 366, a wood supply module 426, a cool down time module 428, a food rest time module 430, notes module 312, a smoker door module 432, a fuel supply module 434, a remote start/stop/pause module 436, a custom notifications module 442, and a keep warm mode module 438. Some or all of these modules may appear in other modules of the mobile application interface 300.

In some embodiments, the live smoking module 402 contains multiple displays or views, arranged linearly or hierarchically, and may be customized by the operator. In some embodiments, the live smoking module 402 has one or more menus. In other embodiments, more than one of the sub-modules is simultaneously displayed to the user.

The live smoking module 402 enables the user to remotely view the status, for example “on,” “paused,” or “off,” and progress of the current smoking or cooking session. In some embodiments, the user may make modifications in the live smoking module 402 to the current smoking or cooking session, or the user may view information about the functioning of the smoking appliance 102 and its components. In some embodiments, the live smoking module 402 is internet browser-based. In some embodiments, the user's input in one of the live smoking module 402s is transmitted by the remote computing device 104, through the communication network 106, to the control module 202 via the network connection module 218.

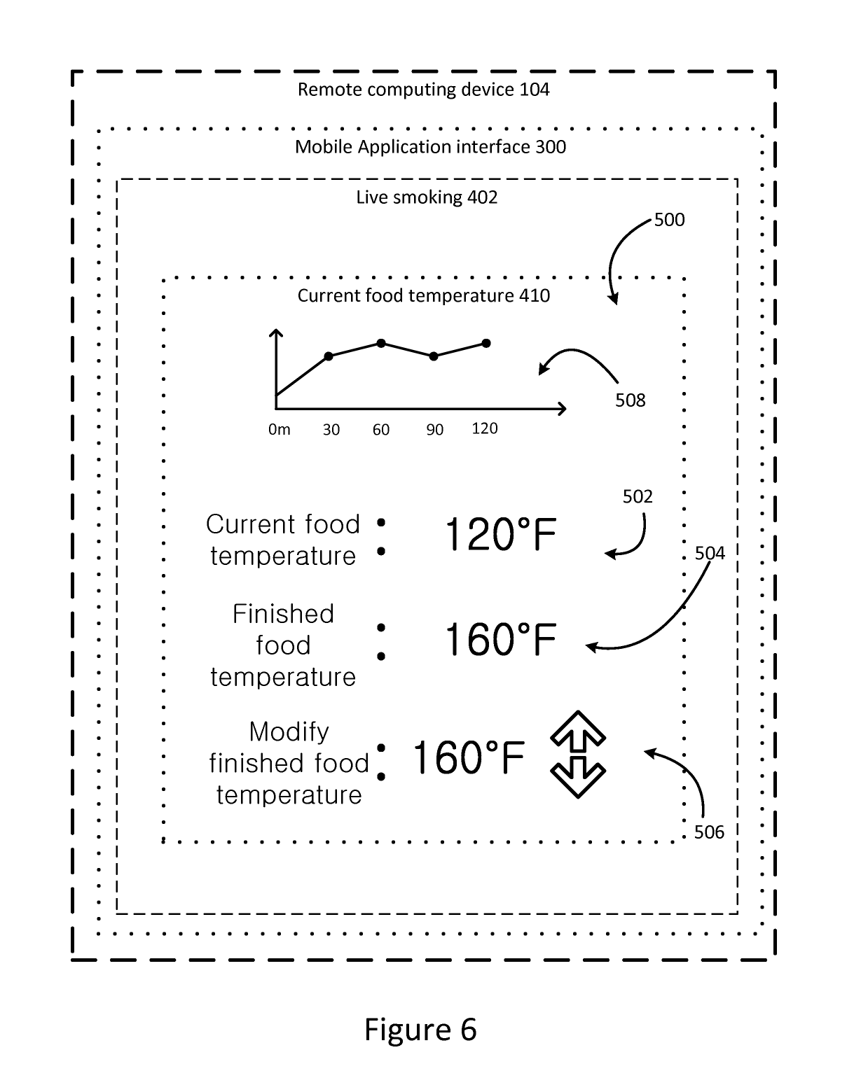

The current food temperature module 410 is an optional module in the live smoking module 402. In some embodiments, the current food temperature module 410 displays the current temperature reading of the food thermometer 206, which is sent to the remote computing device 104 through the communication network 106. In other embodiments, the current food temperature module 410 is displayed in the temperature control module 306. In still other embodiments, the current food temperature module 410 may enable the user to modify the desired finished food temperature module 374. In yet other embodiments, the current food temperature module 410 enables the user to specify what type of thermometer is being used for the food thermometer 206 in the smoking appliance 102. An example of one embodiment of the current food temperature module 410 is illustrated and described in more detail with reference to FIG. 6.

The elapsed cooking time module 412 is an optional module in the live smoking module 402. In some embodiments, the elapsed cooking time module 412 displays the time elapsed since the user started the smoking or cooking session via the user interface 208 or the remote computing device 104. In other embodiments, the elapsed cooking time module 412 displays the current reading of the timer 220.

The estimated finish time module 414 is an optional module in the live smoking module 402. In some embodiments, the estimated finish time module 414 displays when the food will be done smoking or cooking. In some embodiments, the user may adjust the estimated finish time module 414 and the system will adjust the heating element 204 or smoke source 212 accordingly to have the food finish by the newly selected time.

The fuel supply module 444 is an optional module in the live smoking module 402. In some embodiments, the fuel supply module 444 is in communication with the fuel source 214. For example, the fuel source 214 may be a propane gas container with an electronic gauge. In some embodiments, the user may access the fuel supply module 444, which may display how much propane gas is left in the tank. In other embodiments, the fuel supply module 444 may be adapted to monitor and display the amount of fuel remaining. In still other embodiments, the fuel supply module 444 can alert the user when the heating element is no longer receiving fuel.

The current ambient temperature module 416 is an optional module in the live smoking module 402. In some embodiments, the current ambient temperature module 416 is in communication with the ambient temperature sensor 216 and the module displays the current ambient temperature of the smoking appliance 102. In other embodiments, the current ambient temperature module 416 may also display, for example graphically or in a table, the historical ambient temperature of the smoking appliance 102 since the session began. In some embodiments, the current ambient temperature module 416 displays changes to the temperature setting.

The ambient temperature target module 418 is an optional module in the live smoking module 402. In some embodiments, the ambient temperature target module 418 displays the desired ambient temperature of the smoking appliance 102. In some embodiments, the ambient temperature target module 418 enables the user to modify the set ambient temperature of the smoking appliance 102, and the system will adjust the heating element 204 or smoke source 212 accordingly.

The time until next baste module 420 is an optional module in the live smoking module 402. In some embodiments, the time until next baste module 420 displays the number of minutes or hours until the food should be basted again, according to the recipe or cooking plan. In other embodiments, the display will show the time at which the food should be basted. In some embodiments, the time until next baste module 420 has an “ignore” option, where the mobile application will record that a given baste was skipped and add those data to the session history. In other embodiments, the time until next baste module 420 has an option to forward a reminder to another person as, for example, an instant message, an SMS message, or an email.

The power loss warning module 446 is an optional module in the live smoking module 402. In some embodiments, the power loss warning module 446 alerts the user if the electrical or other power supplying the smoking appliance 102 weakens or disappears. This is in contrast to the fuel supply module 444, which monitors the electricity, gas, or other fuel source going into the heating element 204. In some embodiments, some or all of the components of the smoking appliance 102 require electricity, and it is this power supply that the power loss warning module 446 monitors.

The statistical tracking of food temperature module 422 is an optional module in the live smoking module 402. As discussed above, in some embodiments, this module displays the data about the food temperature as registered by the food thermometer 206. In some embodiments, the graphical or other display may also contain the food temperature of a different, previous smoking or cooking session.

The statistical tracking of ambient temperature module 450 is an optional module in the live smoking module 402. As discussed above, in some embodiments, this module displays the data about the ambient temperature of the smoking appliance 102 as registered by the ambient temperature sensor 216. In some embodiments, the graphical or other display may also contain the ambient temperature of a different, previous smoking or cooking session.

The energy usage module 424 is an optional module in the live smoking module 402. In some embodiments, the energy usage module 424 displays the consumed electrical, or other fuel type, energy consumed by the fuel source 214 over the duration of the current smoking or cooking session. In other embodiments, the energy usage module 424 displays the consumed electrical energy consumed by the components of the smoking appliance 102.

The my history module 366 is an optional module in the live smoking module 402. In some embodiments, the my history module 366 enables the user to store all data corresponding to the current smoking or cooking session. In some embodiments, the my history module 366 displays, for example, the type of food, the weight of the food, the time the food was smoked or cooked, the type of smoke source, the temperature of the smoking appliance 102, and the final temperature of the food. In other embodiments, the my history module 366 enables the user to label or name the current smoking or cooking session, or to add notes module 312 to the history. In some embodiments, the my history module 366 is also accessible to view data from previous smoking or cooking sessions.

The smoker door module 432 is an optional module in the live smoking module 402. In some embodiments, the smoker door module 432 tracks when the door, lid or other cover to the smoker, is opened via the door sensor 222. In other embodiments, the smoker door module 432 also displays the current ambient temperature module 416 and current food temperature module 410 before and after the smoker door was opened. In some embodiments, the smoker door module 432 sends alerts to the user through the event notification module 310.

The cool down time module 428 is an optional module in the live smoking module 402. In some embodiments, the cool down time module 428 displays the set amount of time for the food to cool down after the heating and/or smoking session finishes. In other embodiments, the user may, in advance or during the cool down, modify the set amount of time for cool down via the cool down time module 428.

The food rest time module 430 is an optional module in the live smoking module 402. In some embodiments, the food rest time module 430 displays the set amount of time for the food to rest after the heating and/or smoking session finishes. In other embodiments, the user may, in advance or during the rest time, modify the set amount of time for food resting via the food rest time module 430.

The notes module 312 is illustrated and described in more detail with reference to FIG. 3. In some embodiments, the notes module 312 is in the live smoking module 402.

The keep warm mode module 438 is an optional module in the live smoking module 402. In some embodiments, the keep warm mode module 438 displays the time the user plans to remove the food from the smoking apparatus. In some embodiments, the keep warm mode module 438 may be activated to turn on the heating element 204 at a low setting so that the food is still warm when removed from the smoking appliance 102. In some embodiments, the user may pre-select to have the keep warm mode module 438 automatically initiate after, for example, the smoking or cooking session ends, after the cool down time, or after the food rest time.

The remote start/stop/pause module 436 is an optional module in the live smoking module 402. In some embodiments, the remote start/stop/pause module 436 enables the user to, remotely, start, stop, or pause the smoking or cooking session. In some embodiments, the user could prepare the food and place it inside the smoking appliance 102, but not start the smoking or cooking session until after the user and appliance are no longer in the same physical location.

In other embodiments, the user may use the remote start/stop/pause module 436 to stop the cooking session remotely, which may shut all components of the smoking appliance 102 off, or, for example, it may transition the smoking appliance 102 into keep warm mode module 438. In some embodiments, stopping also stops data recordation; if the user were to continue to smoke or cook after stopping, it may be recorded as a new session. In still other embodiments, the user may pause the session using the remote start/stop/pause module 436. In some embodiments, pausing the session may transition the smoking appliance 102 into the keep warm mode module 438 but may not terminate the session for data recording purposes.

The custom notifications module 442 is an optional component in the live smoking module 402. In some embodiments, the user may select notifications to receive during a cooking or smoking session via the event notification module 310. In some embodiments, the user may select to receive notifications about, for example, when the lid or door to the smoking appliance 102 is opened, when the ambient temperature reaches a predetermined temperature, when the smoking or cooking session is over, when it is time to baste the food, when the cool down period begins, when the fuel supply is running low, when the appliance loses power, or when the food temperature reaches a predetermined temperature.

FIG. 5 is a block diagram illustrating some of the sub-modules of the start new smoke module 308, which may be accessed through the mobile application interface 300 on the remote computing device 104. The start new smoke module 308 has multiple sub-modules, including, for example, a finish time module 351, a food type module 352, a food dimensions module 354, a start time module 356, a reference module 304, a fuel type module 360, a smoke source module 362, a notes module 312, the my history module 366, a basting times module 368, a food weight module 370, a custom notifications module 442, a cold smoke mode module 440, a finished food temperature module 374, and a my favorites module 392. Some or all of these modules may appear in other modules of the mobile application interface 300.

In some embodiments, the start new smoke module 308 contains multiple views, arranged linearly or hierarchically, and may be customized by the operator. In some embodiments, the start new smoke module 308 has one or more menus. In other embodiments, more than one of the sub-modules is simultaneously displayed to the user. In some embodiments, the start new smoke module 308 is accessed through a web-browser.

The start new smoke module 308 enables the user to customize or remotely start a new smoking or cooking session. In some embodiments, after each parameter has a value entered, the mobile application, or browser-based application, uses an algorithm to calculate, for example, the proper temperature profile and time for the smoking or cooking session. Temperature profile, as used herein, may mean the temperature or temperatures of the smoking appliance 102 at various times during the smoking or cooking session. Alternatively, temperature profile could also mean the temperature differential within the smoking appliance 102. In some embodiments, the calculated information is sent to the control module 202 via the communication network 106, and the control module 202 implements the received parameters using the components of the smoking appliance 102.

The finish time module 351 is an optional module in the start new smoke module 308. In some embodiments, the user may enter the desired finish time into the finish time module 351, by, for example, using icons on the remote computing device 104 screen or by entering a time using an alphanumeric input. Alternatively, in some embodiments, when the user selects a recipe or previous smoke, the system will calculate, using an algorithm, when the smoking or cooking session will end if started immediately. In other embodiments, the user may, by entering the desired finish time in the finish time module 351, instruct the system to delay starting so that the session finishes at the desired finish time.

The food type module 352 is an optional module in the start new smoke module 308. In some embodiments, the food type module 352 is a drop-down menu and the user selects the food type, for example, beef, chicken, pork, cheese, vegetables. In other embodiments, the food type module 352 contains different types of cuts within each broader food type, for example, beef brisket or pork shank. In still other embodiments, the user may enter the food type into the food type module 352 using an alphanumeric input. In some embodiments, the mobile application uses the food type in the algorithm when calculating the proper temperature profile and time for the smoking or cooking session.

The food dimensions module 354 is an optional module in the start new smoke module 308. In some embodiments, the food dimensions module 354 enables a user to enter the dimensions of the food being smoked or cooked. In some embodiments, the user may input, for example, the approximate length, width, and height of a food. In other embodiments, the food dimensions module 354 will present the user with different geometric polyhedra, such as a cylinder, rectangular prism, triangular prism, or sphere, and then ask for the dimensions of the food. In some embodiments, the mobile application uses these dimensions in the algorithm when calculating the proper temperature profile and time for the smoking or cooking session.

The start time module 356 is an optional module in the start new smoke module 308. In some embodiments, the start time module 356 and the finish time module 351 are displayed simultaneously on the remote computing device 104. In some embodiments, the start time module 356 enables the user to enter the time the smoking or cooking session starts. In some embodiments, the mobile application uses the start time to calculate the expected finish time of the smoking or cooking session.

The reference module 304 is an optional module in the start new smoke module 308. In some embodiments, the reference module 304 contains, or has access to, recipes. In other embodiments, the reference module 304 has a search function that can search, for example, saved recipes or a database, stored locally or remotely. In some embodiments, the user may select a recipe in the reference module 304 and the system will populate the required parameters, such as cooking time and temperature profile. In some embodiments, after the system populates the start new smoke module 308 with parameters from a recipe, the user may modify some or all of the populated parameters. The reference module 304 is also shown and described in detail with reference to FIG. 3.

The fuel type module 360 is an optional module in the start new smoke module 308. In some embodiments, the fuel type module 360 enables a user to select, by, for example, a drop-down menu or enter alphanumerically, the type of fuel to be used in the fuel source 214. In other embodiments, the user may enter information about the source of the fuel, for example, a 4.6 gal propane tank, a 500 gal propane tank, electricity, a cord of wood, or piped natural gas. In some embodiments, the mobile application uses these data to calculate the parameters required for the smoking or cooking session. In other embodiments, the system automatically stores the previously entered fuel type so that the user does not need to re-enter the same fuel type every time a new smoke is started.

The smoke source module 362 is an optional module in the start new smoke module 308. In some embodiments, the smoke source module 362 enables a user to select using, for example, a drop-down menu or alphanumeric input, the source of smoke to be used in the smoke source 212. Types of smoke source are described in more detail with reference to FIG. 2. In some embodiments, the mobile application uses the type of smoke source to calculate the parameters required for the smoking or cooking session based on known information about the way the type of smoke source burns or smokes.

The notes module 312 is an optional module in the start new smoke module 308. In some embodiments, the user may access the notes module 312 to view saved notes about previous smoking or cooking sessions. The notes module 312 is illustrated and described in more detail with reference to FIGS. 3 and 4.

The my history module 366 is an optional module in the start new smoke module 308. In some embodiments, the my history module 366 contains the stored data of all previous smoking or cooking sessions. In some embodiments, the my history module 366 contains sessions stored using the store in my history module 448. In some embodiments, the my history module 366 is accessible through the reference module 304. In other embodiments, the my history module 366, when a user selects a particular session, displays all or some of the data recorded during that session, including, for example, the temperature profile, time, basting times, number of times the lid or door to the smoking appliance 102 was opened, and cool down or resting periods.

The basting times module 368 is an optional module in the start new smoke module 308. In some embodiments, the basting times module 368 enables a user to input, for example, as elapsed time from the start or a time of day, when and the number of times the food should be basted. In some embodiments, when the user selects a recipe or previous session, the basting times may be automatically populated and the user may alter the basting times in the basting times module 368. In some embodiments, the times inputted in the basting times module 368 may be displayed by the time until next baste module 420. In other embodiments, the times inputted into the basting times module 368 will be populated into the event notification module 310.

The food weight module 370 is an optional module in the start new smoke module 308. In some embodiments, the food weight module 370 enables a user to enter by, for example, on-screen icons or an alphanumeric input, the weight of the food to be smoked or cooked. In some embodiments, the mobile application associates the food weight with the smoking session so that the food weight will also be displayed in the my history module 366 or my favorites module 392. In other embodiments, the food weight module 370 may be populated by communicating, wirelessly or through a wired connection, with a scale upon which the food is placed. In some embodiments, the mobile application uses the food weight entered into the food weight module 370 to calculate the cooking or smoking session parameters.

The custom notifications module 442 is an optional module in the start new smoke module 308. In some embodiments, the custom notifications module 442 enables the user to select which notifications should be displayed by the event notification module 310 during the smoking or cooking session. In other embodiments, the user may select, or enter, the delivery means of the custom notifications, including, for example, SMS message, email, instant message, or any message conveyed through the remote computing device 104. The custom notifications module 442 is illustrated and described in more detail with reference to FIG. 4.

The cold smoke mode module 440 is an optional module in the start new smoke module 308. In some embodiments, the user may select the cold smoke mode module 440 to enter parameters for a cold smoking session. In other embodiments, the reference module 304, my history module 366, or my favorites module 392 may contain recipes or prior sessions of cold smoking. In some embodiments, the mobile application uses the parameters entered in the cold smoke mode module 440 in the algorithm when calculating the proper temperature profile and time for the smoking or cooking session.

The finished food temperature module 374 is an optional module in the start new smoke module 308. In some embodiments, the user may enter, using on-screen icons or an alphanumeric input, the desired finished food temperature in the finished food temperature module 374. In other embodiments, the finished food temperature module 374 may suggest a temperature based on the food type entered in the food type module 352. In other embodiments, the finished food temperature module 374 will be populated after the user selects a recipe or previous smoking or cooking session. In still other embodiments, the finished food temperature module 374 may enable the user to select the location of the desired temperature, including, for example, the surface or core temperature of the food. In yet another embodiment, the finished food temperature module 374 may enable the user to enter, using on-screen icons or an alphanumeric input, the type of food thermometer 206 in the smoking appliance 102.

The my favorites module 392 is an optional module in the start new smoke module 308. In some embodiments, the my favorites module 392 displays selectable recipes or prior smoking or cooking sessions that the user has previously selected as a favorite. In some embodiments, the user may mark a recipe as a favorite in the reference module 304 or the my history module 366. In some embodiments, the user may select a recipe in the my favorites module 392 and the system will populate the required parameters, such as cooking time and temperature profile. In some embodiments, after the system populates the start new smoke module 308 with parameters from a recipe, the user may modify some or all of the populated parameters. In still other embodiments, the user may send their favorites to a different remote computing device or receive favorites from a different remote computing device.

FIG. 6 is an illustration of an example screen display of the current food temperature module 410, which is a sub-module of the live smoking module 402, which is a module of the mobile application interface 300 that may be accessed on the remote computing device 104. In some embodiments, the current food temperature display 500 includes a graphic 508, the current food temperature display 502, the finished food temperature display 504, and modify finished food temperature display 506. In some embodiments, the current food temperature display 500 may be customizable and include more or fewer modules than those illustrated in FIG. 6.

The graphical display 508 is an optional module in the current food temperature display 500. In some embodiments, the graphical display 508 shows an independent variable, for example, time, on the x-axis, and a dependent variable, for example, food temperature, on the y-axis. In some embodiments, when the user access the current food temperature display 500, the graphical display 508 plots a new point on the Cartesian plane corresponding to, for example, the current time and temperature of the food. In other embodiments, the graphical display 508 may be a table, where the independent and dependent variables are in separate, but corresponding columns.

The current food temperature display 502 is an optional module in the current food temperature display 500. In some embodiments, the display shows the real-time measurement of the food thermometer 206. In some embodiments, the current food temperature display 502 shows the temperature in Fahrenheit, Celsius or Kelvin.

The finished food temperature display 504 is an optional module in the current food temperature display 500. In some embodiments, the finished food temperature display 504 shows the temperature entered in the finished food temperature module 374. In some embodiments, the current food temperature display 502 shows the temperature in Fahrenheit, Celsius or Kelvin.

The modify finished food temperature display 506 is an optional module in the current food temperature display 500. In some embodiments, the modify finished food temperature display 506 shows the temperature entered in the finished food temperature module 374. In some embodiments, the user can adjust the desired finished food temperature using, for example, on-screen icons or an alphanumeric input. In some embodiments, when the user adjusts the finished food temperature on the display 506, the system automatically adjusts the parameters for the session, for example, the ambient temperature profile and time.

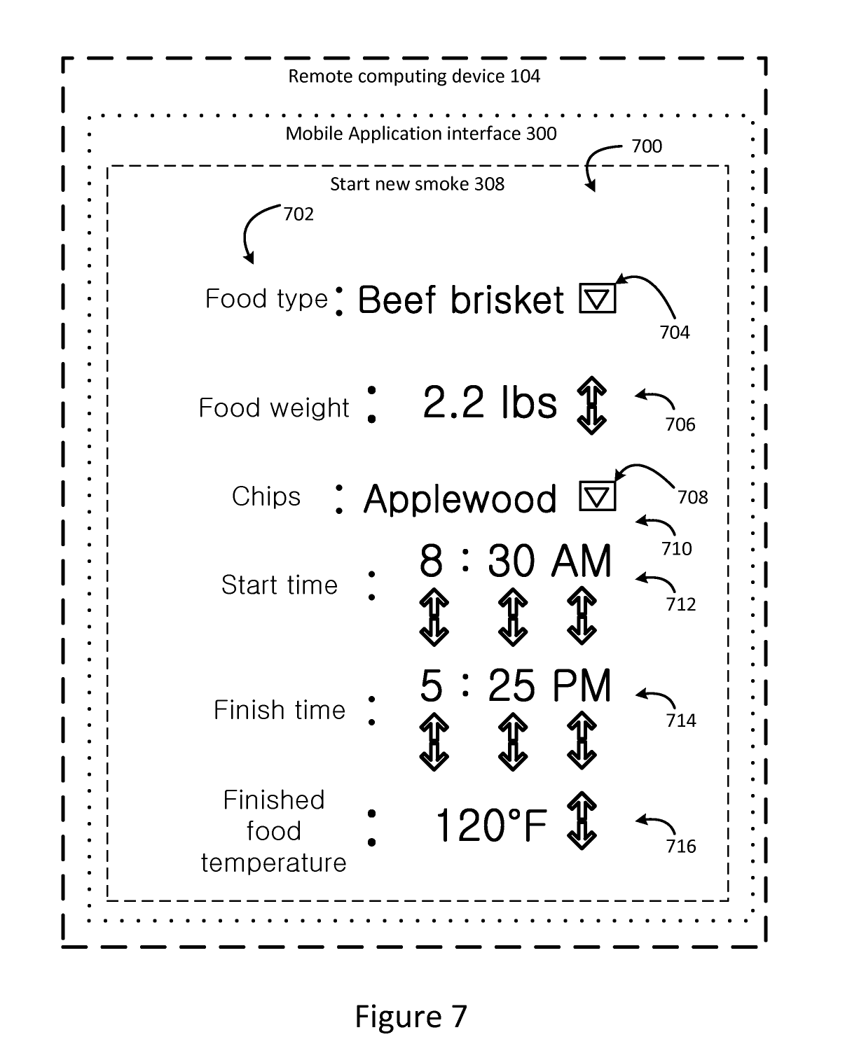

FIG. 7 is an illustration of an example screen display of the start new smoke module 308, which is a module of the mobile application interface 300 that may be accessed on the remote computing device 104. In some embodiments, the start new smoke display 700 includes a food type display 702, a food weight display 707, a chips display 710, a start time display 712, a finish time display 714, and a finished food temperature display 716. In some embodiments, the start new smoke display 700 may be customizable and include more or fewer modules than those illustrated in FIG. 6.

The food type display 702 is an optional module in the start new smoke display 700. In some embodiments, the user may enter the food type by, for example, a drop-down menu 704 or using an alphanumeric input. In some embodiments, the food type display 702 functions the same as the food type module 352, which is illustrated and described in more detail with reference to FIG. 5.

The food weight display 706 is an optional module in the start new smoke display 700. In some embodiments, the user may enter the food weight to be cooked or smoked using, for example, on-screen icons, an alphanumeric input, or a drop-down menu. In some embodiments, the food weight display 706 functions the same as the food weight module 370, which is illustrated and described in more detail with reference to FIG. 5.

The chips display 708 is an optional module in the start new smoke display 700. In some embodiments, the user may enter the chips type by, for example, a drop-down menu or using an alphanumeric input. In some embodiments, the chips are the smoke source 212. In some embodiments, the chips display 710 functions the same as the smoke source module 362, which is illustrated and described in more detail with reference to FIG. 5.

The start time display 712 is an optional module in the start new smoke display 700. In some embodiments, the user may enter the start time using, for example, on-screen icons, an alphanumeric input, or a drop-down menu. In some embodiments, the start time display 712 functions the same as the start time module 356, which is illustrated and described in more detail with reference to FIG. 5.

The finish time display 714 is an optional module in the start new smoke display 700. In some embodiments, the user may enter the finish time using, for example, on-screen icons, an alphanumeric input, or a drop-down menu. In some embodiments, the finish time display 714 functions the same as the finish time module 351, which is illustrated and described in more detail with reference to FIG. 5.

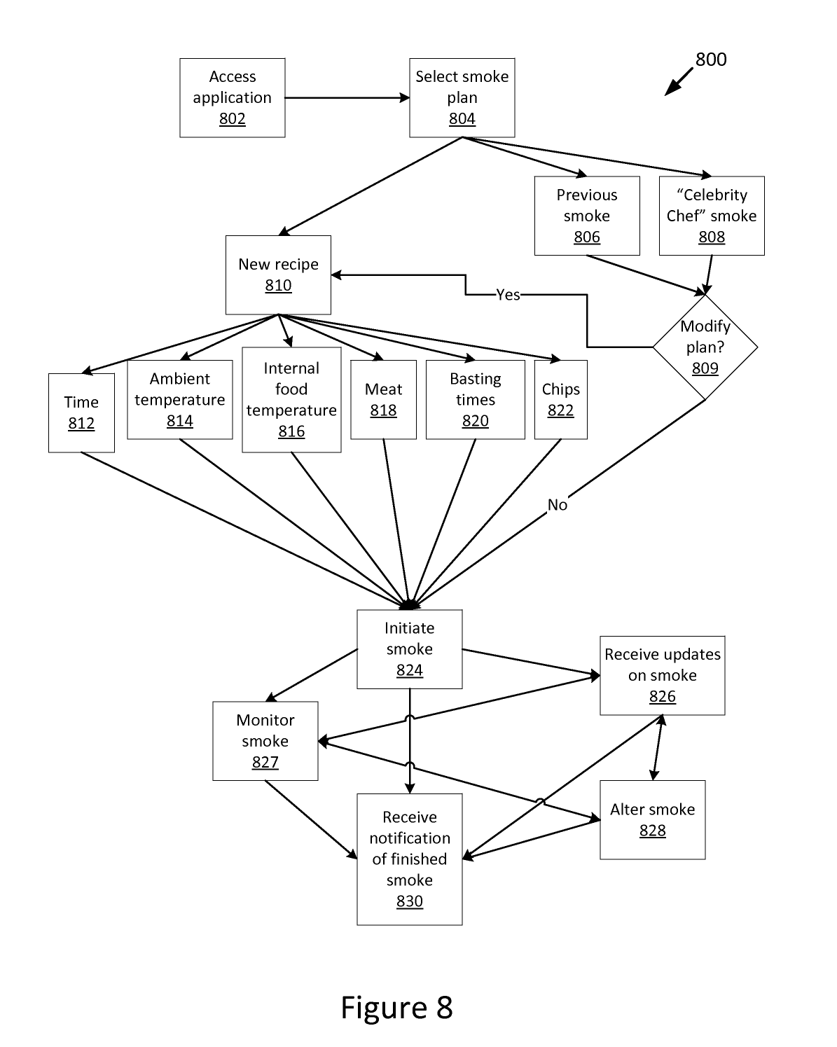

FIG. 8 illustrates an example decisional flowchart 800 for the mobile application interface 300. The example decisional flowchart 800 is for starting a smoke session, but a similar decision-making process would also apply to any of the other cooking types mentioned above. Other embodiments may include more or fewer operations.

In this embodiment, the user begins at operation 802 by accessing the application on the remote computing device 104. In other embodiments, the user may access the application on a browser-enabled device, such as, for example, a laptop or desktop computer. In the application, the user selects start new smoke module 308, which then prompts the user at operation 804 to select a smoke plan. Next, the user decides whether to start a new recipe, use a previous smoke, or pick a recipe from the reference module 304, for example, a “celebrity chef” or publication.

If the user selects a previous smoke, from, for example, the my history module 366 or my favorites module 392, control is passed to operation 806, and at operation 809 the application prompts the user whether they wish to modify the selected smoke plan. If the user inputs that they do not want to modify the plan, control is passed to operation 824 where they may initiate the smoking session. If the user inputs that they do want to modify the plan, control is passed to operation 810, where the data from the selected recipe automatically populates the fields. At operation 810, the user may modify any parameter and then proceed to operation 824.

Alternatively, if the user selects new recipe at operation 804, control is passed to operation 810. In some embodiments, the user may select cold smoke mode 440 at operation 810. Additionally, at operation 810 the user may, for example, enter a name for the smoke session. Then, the user may, in any order, enter the following parameters for the new recipe or smoking session.

At operation 812, the application prompts the user to enter any of the following: the desired start time, finish time, or total smoking time. At operation 814, the application prompts the user to enter the desired ambient temperature of the smoking appliance 102 during the smoke. In some embodiments, the user may enter multiple temperatures during the smoking session, for example, 220° F. for three hours and then 200° F. for four hours.

At operation 816, the application prompts the user to enter the desired finished internal or external food temperature. In some embodiments, the user may enter the type of food thermometer 206 that is in the smoking appliance 102. At operation 818, the application prompts the user to enter the food type module 352, food dimensions module 354, and food weight module 370. At operation 820, the application prompts the user to enter the times, if any, the food should be basted 368. In some embodiments, the user may enter a time of day or the elapsed time from the start of the smoke, and the system may provide reminders via the event notification module 310.

At operation 822, the application prompts the user to enter the smoke source module 362, which in some embodiments, may be wood chips or other organic, synthetic or man-made material. Again, in some embodiments, the user may not enter information for all the above-listed parameters, or the user may enter information in additional modules for parameters not listed.

Next, at operation 824, the application displays the entered parameters for the smoke. The user may select and modify any parameter or the user may select start smoke or delay starting smoke. Additionally, the user enters any notifications 372 they wish to receive.

As the smoke progresses, the user may, at operation 827, monitor via the remote computing device 104 or another browser-enabled device. Additionally, the user may receive notification updates about the smoke at operation 826 on the remote computing device 104 or other device. Further, the user may make alter the parameters of the smoke at operation 828, such as changing the ambient temperature using the live smoking module 402. Last, at operation 830, the user receives notification of the finished smoke, at which point the user can instruct the smoking appliance 102 to keep the warm mode module 438, cool down time module 428, or let the food rest time module 430.

The flow diagrams depicted herein are just examples. There may be many variations to these diagrams or the steps (or operations) described therein without departing from the spirit of the disclosure. For instance, the steps may be performed in a differing order, or steps may be added, deleted or modified.

While embodiments have been described, it will be understood that those skilled in the art, both now and in the future, may make various improvements and enhancements can be made.

What is claimed is:

1. A system, comprising:
a smoking appliance, comprising a heating element and a smoking element;
a remote computing device; and
a communication network;
wherein the smoking appliance and the remote computing device are in communication via the communication network; and
wherein the remote computing device is configured to control the smoking appliance remotely.

2. The system of claim 1, wherein the smoking appliance additionally comprises an ambient temperature sensor.

3. The system of claim 2, wherein the smoking appliance further comprises a control module operatively connected to the communication network and configured to modulate an exhaust vent of the heating element.

4. The system of claim 3, wherein the remote computing device further comprises an application configured to control the smoking appliance via the control module.

5. The system of claim 3, further comprising a food temperature sensor, wherein the remote computing device estimates an amount of time until the food in the smoking appliance reaches a set temperature.

6. The system of claim 5, wherein the remote computing device provides an alert when the food has reached a desired temperature.

7. The system of claim 5, wherein the control module is configured to record the food temperature at predetermined intervals, and wherein the remote computing device is configured to display the recorded food temperature.

8. A method for controlling a smoking appliance, comprising:
accessing an application;
entering a temperature for the smoking appliance;
initiating operation of the smoking appliance; and
monitoring the smoking appliance remotely by using an application on a remote device.

9. The method of claim 8, further comprising entering a time a food should remain in the smoking appliance.

10. The method of claim 8, further comprising entering a desired finished food temperature.

11. The method of claim 10, further comprising:
entering a type of food; and
entering a weight of the food.

12. The method of claim 8, further comprising:
entering a time a food should remain in the smoking appliance;
entering a desired finished food temperature; and
selecting a recipe, wherein said recipe enters the time and the temperature into the application.

13. The method of claim 12, further comprising entering a type of smoke source.

14. The method of claim 12, further comprising:
receiving an update on a remote device; and
modifying operation of the appliance using the remote device.

15. An food smoking device, comprising:
a container comprising an upper portion, a lower portion, and a closing portion;
a smoking element arranged to receive a smoke source and positioned in the lower portion of the container;
a support element for supporting a food to be smoked and positioned in the upper portion of the container;
a control unit supported by the container;
an ambient temperature sensor configured to measure the temperature inside the container and operatively coupled to the control unit;
a network communication unit operatively coupled to the control unit.

16. The food smoking device of claim 15, wherein the closing portion is hingedly connected to the container.

17. The food smoking device of claim 15, wherein the smoking element comprises a smoking element intake vent and a smoking element exhaust vent, and wherein the control unit is configured to actuate the smoking element intake vent and the smoking element exhaust vent.

18. The food smoking device of claim 16, wherein the network communication unit is configured to connect to a wireless network.

19. The food smoking device of claim 18, wherein the control unit is configured to receive control instructions via the network communication unit.

20. The food smoking device of claim 15, further comprising a food temperature sensor and one or more additional ambient temperature sensors.
